(19) United States
(12) Patent Application Publication
(10) Pub. No.: US 2010/0102968 A1
(43) Pub. Date: Apr. 29, 2010

(54) ELECTRONIC ARTICLE SURVEILLANCE DEVICE AND RELATED ASSEMBLY AND METHOD

(75) Inventors: Kathie Bulson, Pompano Beach, FL (US); Debra Fisher, Roswell, GA (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(73) Assignee: TAG (BVI) LTD., Road Town (VG)

(21) Appl. No.: 12/490,234

(22) Filed: Jun. 23, 2009

Related U.S. Application Data
(60) Provisional application No. 61/074,900, filed on Jun. 23, 2008.

(51) Int. Cl. G08B 13/14; H04N 1/44

(52) U.S. Cl. 340/572.8; 358/1.9

(57) ABSTRACT

An acousto-magnetic surveillance device for attachment to an article includes a first metal strip that is magnetostrictive with a predetermined resonance frequency, a second metal strip that is selectively magnetizable adjacent to the first metal strip, a housing at least partially surrounding the first and second metal strips and allowing oscillation therebetween, and a foil reflector adjacent to the housing and more proximate to the second metal strip than the first metal strip. The device is adapted for attachment to the article with the foil reflector between the article and the first and second metal strips. The device can be attached over a container closure with a pair of adhesive segments attached to the container body adjacent to the closure and a pair of intermediate segments extending between the adhesive segments and the tag. The intermediate segments are removable from over the closure by detachment from the adhesive segments.

### CROSS-REFERENCE TO RELATED APPLICATION

This application claims the benefit of U.S. Provisional Application Ser. No. 61/074,900, filed on Jun. 23, 2008, the contents of which application are hereby incorporated by reference in their entirety.

### BACKGROUND OF THE INVENTION

Electronic article surveillance (EAS) is used to prevent the theft of merchandise from many stores and other commercial venues. One common form of EAS involves the use of systems including detectors and tags, such as magnetic tags, acousto-magnetic (AM) tags, radio frequency (RF) tags and microwave tags, which are selectively removable and/or de-activatable by store personnel. The tags are attached to articles of merchandise. The detectors are arranged proximate to exits and configured to generate an alarm when detecting a tag that has not been properly de-activated or removed.

While such systems have helped reduce theft, many articles have been found unsuitable for tagging. For instance, the physical configuration of an article or its packaging may render placement of a tag awkward or impractical. Also, metallic components on the article or associated containers may shield the tag or otherwise interfere with detection of the tag by the detector.

### SUMMARY OF THE INVENTION

In view of the foregoing, it is an object of the present invention to provide an improved electronic article surveillance device, and related assemblies and methods.

According to an embodiment of the present invention, an acousto-magnetic surveillance device for attachment to an article includes a first metal strip that is magnetostrictive with a predetermined resonance frequency, a second metal strip that is selectively magnetizable adjacent to the first metal strip, a housing at least partially surrounding the first and second metal strips and allowing oscillation therebetween, and a foil reflector adjacent to the housing and more proximate to the second metal strip than the first metal. The device is adapted for attachment to the article with the foil reflector between the article and the first and second metal strips.

According to a method aspect of the present invention, a method of attaching an electronic surveillance tag over a metallic surface of an article includes dimensioning a foil reflector to enhance performance of the tag, positioning the foil reflector between the tag and the metallic surface, and securing the tag and the foil reflector over the metallic surface.

An acousto-magnetic surveillance device according to the present invention can advantageously allow attachment of AM tags to metallic surfaces without unacceptable degradation in the detectability of the tag.

According to another embodiment of the present invention, a container assembly includes a container body defining an interior volume and having an opening formed therein, a closure covering the opening, an electronic article surveillance device arranged over the closure, the device including an electronic surveillance tag, a pair of adhesive segments attached to the container body adjacent to the closure and a pair of intermediate segments extending between the adhesive segments and the tag. The intermediate segments and the tag are removable from over the closure by detachment from the adhesive segments.

A container assembly including an electronic surveillance device according to present invention allows the electronic surveillance device to be readily removed with exposing contents of the container to the adhesive or other surveillance device components. The electronic surveillance device can also be attached easily to cylindrical containers, and other, awkwardly shaped, packaging.

These and other objects, aspects and advantages of the present invention will be better understood in view of the drawings and following detailed description of preferred embodiments.

### BRIEF DESCRIPTION OF THE DRAWINGS

FIG. 1 is a top plan view of an electronic article surveillance device, according to an embodiment of the present invention;

FIG. 2 is a sectional view taken along line 2-2 of FIG. 1;

FIG. 3 is a perspective view of a container assembly including an electronic surveillance device, according to another embodiment of the present invention; and

FIG. 4 is a perspective view of the container assembly of FIG. 3, with a portion of the electronic surveillance device removed.

### DETAILED DESCRIPTION OF PREFERRED EMBODIMENTS

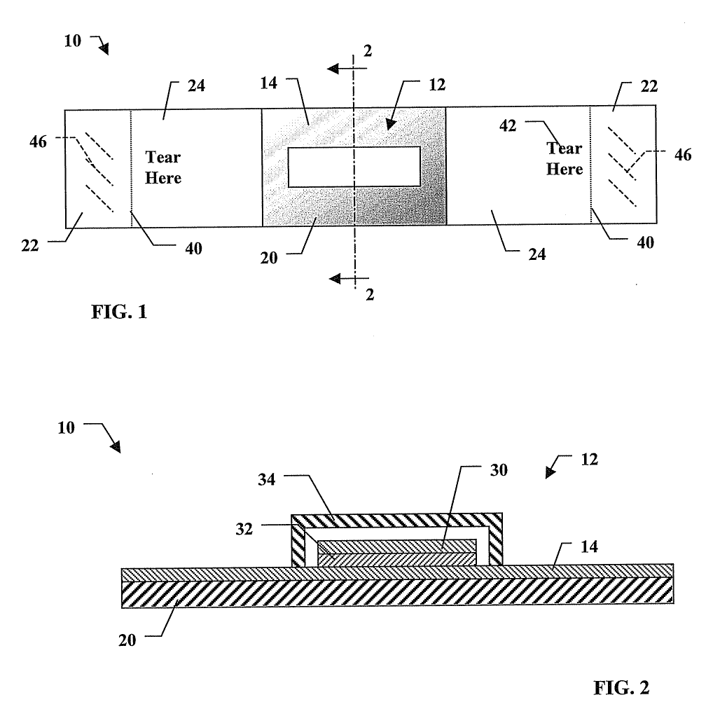

Referring to FIGS. 1 and 2, according to an embodiment of the present invention, an electronic article surveillance device 10 includes an electronic surveillance tag 12 arranged over a foil reflector 14 and adapted for attachment to an article by a plurality of segments 20-24.

The electronic surveillance tag 12 is advantageously an acousto-magnetic tag having a first metal strip 30 and a second metal strip 32 arranged in a housing 34. The first strip 30 is formed from a magetostrictive material having a predetermined resonance frequency. The second strip 32 is selectively magnetizable. The housing 34 permits relative motion therein between the strips 30, 32.

As is known in the art, an acousto-magnetic tag is activated by magnetizing the second strip 32, which generates a biasing magnetic field. The biasing magnetic field offsets the magnetic anisotropy of the first strip 30. Unless deactivated by demagnetizing the second strip 32, the first strip 30 will then vibrate strongly in response to periodic transmissions from the detectors (not shown) at the resonant frequency (typically about 58 kHz). The vibration of the first strip 30 can be picked up by the detectors.

The present inventors have determined that certain metals (particularly, ferrous metals) will tend to disperse the biasing field, resulting in a weakening or “bleeding” of the field, such that the detectors may not be able to detect the vibration of the first strip 30. Additionally, various materials may also exert a shielding effect.

The electronic article surveillance device 10 can be attached to a metallic surface of the article by the segments 20-24 such that the foil reflector 14 is between the metallic surface and the tag 12. The foil reflector 14 inhibits dispersal of the biasing field and can also be dimensioned help properly tune the vibration of the first strip 30 in response to the detector transmissions. As a result, the negative effect of the metallic surfaces on the tag 12 is mitigated and the output of the tag is enhanced.

The segments 20-24 are preferably formed of a plastic film, although other materials could be used, such as paper. The segments include a middle segment 20, adhesive segments 22 and intermediate segments 24. The foil reflector 14 is located on the middle segment 20, and can be deposited or otherwise adhered thereto or integrated therein.

The adhesive segments 22 have a high tack, permanent adhesive on a lower surface thereof and are each separated from the middle segment 20 by a respective one of the intermediate segments 24. Preferably, no adhesive, or only a low tack, releasable adhesive, is placed on lower surfaces of the middle and intermediate segments—such that the adhesive segments 22 will strongly adhere to the article but the middle and intermediate segments 20, 24 will not. Some low tack adhesive properties of one or more of the middle or intermediate segments can be useful for handling during the dispensing process of the device 10.

Lines of weakness 40, such as perforations, are preferably formed between the adhesive segments 22 and the intermediate segments 24. The intermediate segments 24 and middle segment 20, along with the tag 12 and foil reflector 14, can then be removed from the article by detachment from the adhesive segments 22.

The upper surfaces of the segments 20-24 are preferably printable with text 42, as well as with anti-counterfeit ink or other taggants. Tamper evident features, such as scoring 46, can also be formed in the segments 20-24.

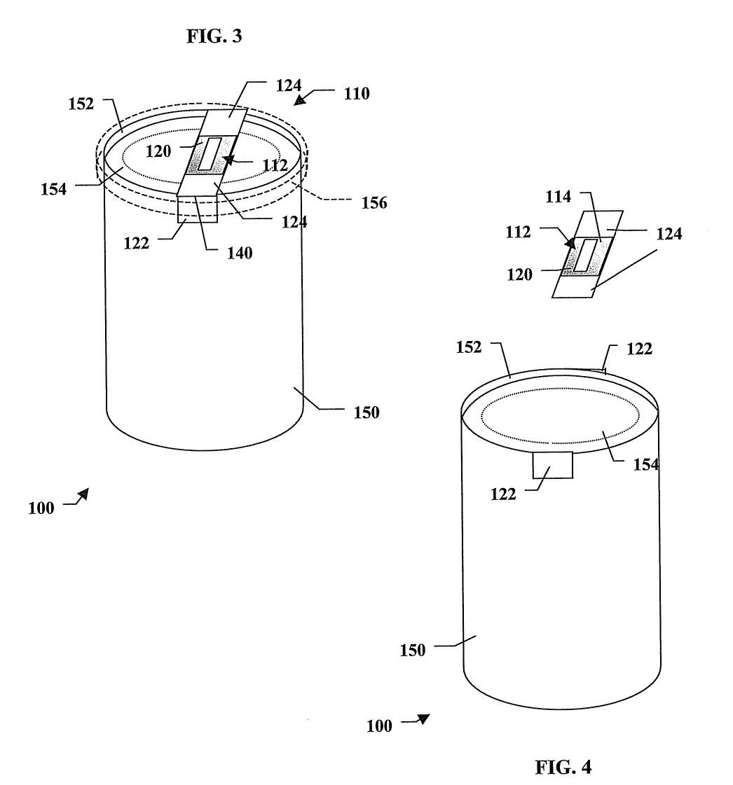

Referring to FIGS. 3 and 4, according to another embodiment of the present invention, a container assembly 100 includes an electronic article surveillance device 110 and a container body 150. The container body 150 defines an interior volume and has an opening 152 defined therein. A closure 154, such a metallic foil or disc extends across the opening 152. A resealable lid can 156 be arranged over the opening 152 and the electronic article surveillance device 110. To help accommodate the electronic article surveillance device 110, the closure 154 can be recessed into the opening 152.

The electronic article surveillance device 110, which can be substantially similar to the device 10, includes an electronic surveillance tag 112 connected to the container body by segments 120-124. The segments include a middle segment 120 to which the tag 112 is attached, preferably above a reflector foil 114 when used in connection with a metallic closure. Adhesive segments 122 strongly adhere to the container body 150 adjacent to the opening 152 with a high tack, permanent adhesive on their under surfaces.

Intermediate segments 124 extend between the adhesive segments 122 and the middle segment 120, and are dimensioned such that the tag 112 can be located over the opening without the need to adhere the adhesive segments directly to the closure 122. Lines of weakness 140 are formed between the adhesive segments 122 and the intermediate segments 124.

A user can then readily remove the intermediate segments 124, middle segment 120 and tag 112 without having to remove the adhesive sections 122 (as seen in FIG. 4). In addition to ease of removal, the risk of contamination of the contents of the container body 150 with adhesive residue or components of the tag 112 is significantly reduced. Alternately, the electronic surveillance device 110 can be attached directly to the closure 154.

While not necessarily limited to a particular container body shape, the present invention is particularly advantageous in connection with cylindrical containers, which can present a difficult geometry for attachment of electronic surveillance devices. The present invention is also particularly advantageous for foodstuff containers, such as powdered baby formula, where the introduction of foreign residues or other elements is highly undesirable. Additionally, locating the surveillance device under a lid helps hide the device from sight and avoids interference with labeling.

The electronic surveillance device 110 can also integrally incorporate or be used in tandem with a primary label (having, for example, a barcode) and a security and/or metallic seal. A taggant material, such as fine fluorescent or phosphorescent particles, can be applied.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

1. An acousto-magnetic surveillance device for attachment to an article comprising:
a first metal strip that is magnetostrictive and amorphous with a predetermined resonance frequency;
a second metal strip that is selectively magnetizable to generate a biasing magnetic field adjacent to the first metal strip;
a housing at least partially surrounding the first and second metal strips and allowing oscillation therebetween; and
a foil reflector adjacent to the housing and more proximate to the second metal strip than the first metal strip;
wherein the device is adapted for attachment to the article with the foil reflector between the article and the first and second metal strips.

2. The device of claim 1, further comprising a first adhesive segment connected to the foil reflector and adapted for attachment to the article.

3. The device of claim 2, wherein tamper evident scoring is formed in the adhesive segment.

4. The device of claim 2, wherein the first adhesive segment is not releasable once attached to the article.

5. The device of claim 4, further comprising a first intermediate segment between the foil reflector and the first adhesive segment, the first intermediate segment having at least one of: no adhesive and a releasable adhesive.

6. The device of claim 4, further comprising a second adhesive segment first and second adhesive segments being arranged on opposite sides of the foil reflector.

7. The device of claim 6, wherein the first and second adhesive segments are separated from the foil reflector by first and second intermediate segments.

8. The device of claim 7, wherein the first and second intermediate segments are dimensioned to extend across an end surface of the article such that the first and second adhesive segments do not adhere to the end surface.

9. The device of claim 8, wherein lines of weakness are formed between first and second adhesive segments and the first and second intermediate segments, such that the first and second intermediate segments can be removed from the article without removal of the first and second adhesive segments.

10. The device of claim 1, wherein the foil reflector is formed as a metalized plastic film.

11. The device of claim 9, wherein the metalized plastic film forms a middle segment between adjacent intermediate segments and more distant adhesive segments.

12. The device of claim 9, wherein the plastic film is adapted for printing thereon.

13. The device of claim 11, wherein anti-counterfeit ink is printed onto the plastic film.

14. A container assembly comprising:
a container body defining an interior volume and having an opening formed therein;
a closure covering the opening; and
an electronic article surveillance device arranged over the closure, the device including an electronic surveillance tag, a pair of adhesive segments attached to the container body adjacent to the closure and a pair of intermediate segments extending between the adhesive segments and the tag;
wherein the intermediate segments and the tag are removable from over the closure by detachment from the adhesive segments.

15. (canceled)

16. The assembly of claim 14, wherein the tag is an acousto-magnetic tag.

17. The assembly of claim 14, further comprising a removable lid arranged over the closure and the electronic article surveillance device.

18. The assembly of claim 17, wherein the closure is recessed into the opening to accommodate the electronic article surveillance device.

19. The assembly of claim 14, wherein the closure is metallic and the electronic article surveillance device further includes a foil reflector arranged between the closure and the tag.

20. A method of attaching an electronic surveillance tag over a metallic surface of an article, the method comprising:
dimensioning a foil reflector to enhance performance of the tag;
positioning the foil reflector between the tag and the metallic surface; and
securing the tag and the foil reflector over the metallic surface.
